(19) United States
(12) Patent Application Publication
(10) Pub. No.: US 2016/0307652 A1
(43) Pub. Date: Oct. 20, 2016

(54) DEVICE FOR HANDLING AN ABSORBENT CONTROL ROD OF A NUCLEAR REACTOR

(71) Applicants: COMEX NUCLEAIRE, MARSEILLE (FR); COMMISSARIAT A L'ENERGIE ATOMIQUE ET AUX ENERGIES ALTERNATIVES, PARIS (FR)

(72) Inventors: Jean-Luc ARLAUD, CHARLEVAL (FR); Daniel CYPRES, LA TOUR D'AIGUES (FR); Adrien ROBERT, JOUQUES (FR)

(21) Appl. No.: 15/098,333

(22) Filed: Apr. 14, 2016

(30) Foreign Application Priority Data
Apr. 14, 2015 (FR) 15 53250

(51) Int. Cl. G21C 7/14; G21C 7/20

(52) U.S. Cl. CPC G21C 7/14; G21C 7/20; G21Y 2002/30; G21Y 2004/30

(57) ABSTRACT

The present invention relates to a device (1) for handling an absorbent rod (11) for controlling a nuclear reactor, comprising (a) an upper motor compartment (2) positioned on the closing slab (10) of the reactor vat (13), (b) a rod control stem (3), extending in said motor compartment (2) and in a guide sheath (3a) extending inside said vat, characterized in that it comprises (1) a sealed static confinement chamber (5) made of non-magnetic material arranged inside said upper compartment, (2) a first synchronous magnetic coupling system (6a) for transmitting linear translational movement without mechanical contact comprising a first outer component (6a-1) arranged outside said chamber (5), and able to be vertically translated, and a first inner component (6a-2) arranged inside said chamber (5), integral with said rod control stem (3), a magnetic coupling force of said first outer component (6a-1) and said first inner component (6a-2) making it possible, when the first outer component (6a-1) is displaced in vertical translation, for said first inner component (6a-2) and the rod control stem (3) follow a displacement in vertical translation, and (3) said motor compartment (2) comprising first motorized mechanical means for transmitting translational displacements (2a) of said first outer component (6a-1) of said first magnetic coupling system (6a).

### TECHNICAL FIELD

The present invention relates to a device for handling an absorbent rod used for controlling the power of a nuclear reactor, preferably of fast neutron type (FNR), specifically sodium-cooled.

### BACKGROUND OF THE DISCLOSURE

In general, in a nuclear reactor, the constant control of the chain reaction is provided using absorbent rods of neutron-absorbing materials which make it possible to control the neutron power of the reactor, for example, a boron-based material. These absorbent rods are also known as “control rods”. These absorbent rods are arranged vertically able to be vertically translated in sheaths between the fuel rods. These absorbent rods can be raised (extracted) or vertically translated as a function of the desired neutron flow. They thus make it possible to control the reactor. More precisely, the absorbent rods are housed in sheaths with cross sections of geometrical shape identical to the fuel assemblies (in particular of hexagonal shape) in such a way as to form, together, a dense bundle constituting the core of the reactor. The power of the fuel assemblies is zero when the absorbent rods are in their housings; and, it is regulated, from zero power to maximum power, as a function of the height of extraction of the absorbent rods, positioned outside their housings.

Fast-neutron reactors (FNR) are designed to use the fissile material (uranium and plutonium) as nuclear fuel, more completely than in thermal neutron reactors. The coolant can be a liquid metal, such as sodium or a gas such as helium.

### SUMMARY OF THE DISCLOSURE

The present invention more particularly concerns a method for handling an absorbent rod used to control the neutron flow emitted by the fuel assemblies of a nuclear reactor of sodium-cooled fast-neutron reactor type (FNR-Na), by relative translation of a said absorbent rod with respect to its sheath, itself arranged within the fuel rods.

Usually known as “rod control mechanism” in the field in question, the expected functions of a device for handling an absorbent rod are:
Holding the absorbent rod in a given position;
Performing the insertion or extraction of the absorbent rod from its housing in the shape of a sheath among the fuel assemblies constituting the core of the reactor;
Dropping the absorbent rod into its housing in the event of an emergency request to stop the reactor.

The various types of devices for handling an absorbent rod produced previously or existing on reactors in operation have substantially the same design. They comprise, as illustrated in FIG. 1:
an upper motor compartment 2 placed on the closing slab 10 of the reactor tank, enclosing the upper part of a stem commonly known as a rod control stem 3, said compartment 2 enclosing motorized means 2-1 of mechanical transmission 2-2, 2-3 and control of displacement of either pinion/rack or screw-nut type, and
said rod control stem 3 acts as the physical link between said motorized means 2-1, controlling the translational displacement of said control stem at its upper end and a device 4 for gripping the absorbent bars or gripper at its lower end, and
said gripper 4 being capable of seizing the upper end of an absorbent rod 11 (represented in FIG. 1A) arranged in the extension of and in alignment with the control step 3, and
a second gripper control stem 5-1 arranged in a center cavity of the rod control stem, which second gripper control stem controlled by motorized means within said motorization compartment 2 controlling, by its displacements in vertical translation and independent from the rod control stem 3, the operations of opening/closing of the gripper such as grab fingers, and
a guide sheath 3a crossing the closing slab 10 of the vat of the reactor extending inside said vat, said guide sheath enclosing the lower part of the rod control stem 3 extending beneath the closing slab, and
first flexible sealed closing means 7b in the form of metal bellows closing the space between said guide sheath 3a and said rod control stem 3 by authorizing the translation of said rod control stem inside said guide sheath, and
second flexible sealed closing means 7a in the form of metal bellows closing the space between said rod control stem 3 and the second control stem 5-1 of the gripper the translation of said gripper control stem 5-1 inside the rod control stem 3.

Like the rod control stem, the second gripper control stem runs up to the motor compartment 2.

The metal bellows 7a, 7b protect from the sodium aerosols resulting from the evaporation of the high-temperature liquid sodium contained in the reactor vat, the motorization means and other mechanical elements cooperating in relative displacements of the handling device that form the movable part of the rod handling device inside the vat and inside the motor compartment above the vat.

In the absence of said flexible closing bellows, the sodium aerosols would cause an increase in the friction between mechanical elements in relative displacements, and would become fixed in the form of solid deposits on the “cold” parts blocking their operation.

The rod handling device further has:
a device 8b for fast automatic shutdown of the reactor by gravitational fall of the movable equipment including the fall of the rod control stem 3 and of the absorbent rod 11 that is attached thereto; which fall can be operated by the switching off of an electromagnet for magnetically holding 8b two metal parts together (including one placed on the movable part) and
a device 9a for damping the gravitational fall of the movable part. This damper is generally of gas or oil technology, and
a device for injecting argon gas inside the upper compartment 2 acting as barrier to the sodium aerosols (not represented in FIG. 1).

The extraction of the absorbent rod 11 from its sheath 12, by vertical and controller translation, by the movable part of the rod handling device, makes it possible to vary the level of reactivity of the core. This control mode is the normal operation.

In a situation requiring a fast shutdown of the reactivity of the core, the rod handling device must have a function making it possible to insert in a very short time the absorbent rod into its housing inside the vat, thus causing the anti-reactivity necessary for the shutdown of the reactor. The insertion of the absorbent bar into the folded back position is caused by the gravitational fall of the movable part of the handling device. This gravitational fall is engaged by the release of a locking component 8b allowing the fall of the mechanical elements of the movable part of the device with gripping of an absorbent rod at its lower end. This action is seconded by the damping device 9a making it possible to dampen the energy of the gravitational fall of the movable mechanism at the track end, in order to preserve the integrity of the absorbent rod.

The use of the rod control devices that have been in existence for several decades has shown a certain number of mechanical operating defects. The present invention in particular concerns the treatment of mechanical defects resulting from wear or breaks of the sealed metal bellows which had led to sodium rising up along the stems. These leaks are the origin of the observed accumulation of sodium aerosol deposits on the moving mechanical parts, causing friction or even seizure and blocking of the mechanisms requiring maintenance operations.

The present invention more generally has the aim of simplifying the general design of the device to reduce the maintenance operation time thereof.

The main aim of the invention is therefore to strengthen the dependability of these existing rod handling devices, the encountered defects of which are the consequence of the corrosive effects of the sodium aerosols entering into the moving mechanical parts and creating mechanical blockages, essentially caused by the breaking of the metal bellows.

Inventors have looked for solutions for improving the sealed metal bellows pertaining to wave shapes more tolerant to the phenomenon of metal fatigue, or to the installation of a double jacket allowing the detection of the puncture of the first jacket before the breaking of the seal. But the end result of this is only to delay the appearance of the loss of the seal.

This is why the present invention provides a new rod handling device comprising the replacement of the metal bellows by the installation:
of a static confinement barrier separating the rod control stem in a sodium environment atmosphere and all the components of a compartment for transmission of mechanical movement by contact outside the sodium environment, and
magnetic coupling devices for contactless transmission of mechanical movement to said rod control stem through said confinement barrier, in addition to the devices for mechanically transmitting movement by contact existing inside the motor compartment outside said confinement barrier outside the sodium environment.

This transmission of movement implies the implementation of a magnetic coupling system acting through a confinement barrier made of non-magnetic material, in the form of a non-magnetic sealing shroud.

More precisely, the present invention provides a device for handling an absorbent rod for controlling a nuclear reactor, preferably a sodium-cooled fast-neutron reactor (FNR), comprising:
an upper motor compartment positioned on the closing slab of the reactor vat, enclosing motorized means for transmitting control for displacement of a first stem known as the rod control stem,
said rod control stem with its upper part extending in said motor compartment and its lower part extending in a guide sheath extending inside said vat, crossing a cavity of the closing slab of the reactor vat, and
a device for gripping absorbent rods known as a gripper fastened to the lower end of said rod control stem, said gripper being able to seize the upper end of an absorbent rod arranged in the extension of and in alignment with the rod control stem,

characterized in that it comprises:
a sealed static confinement chamber made of non-magnetic material arranged inside said upper compartment, in the form of a shroud comprising a side wall of revolution, preferably cylindrical, open at its base, fastened in a sealed manner to the closing slab of the reactor vat around the cavity of the closing slab crossed by said guide sheath,
a first, synchronous magnetic coupling system for transmitting linear translational movement without mechanical contact, comprising:
a first outer component comprising a block of permanent magnet(s), preferably consisting of alternating permanent magnets separated by soft ferromagnetic elements, said block being arranged inside said upper motor compartment outside said confinement chamber, and able to be vertically translated, and
a first inner component comprising at least one soft ferromagnetic element, arranged inside said confinement chamber, integral with the upper part of said rod control stem, the magnetic coupling force of said first outer component and said first inner component making it possible, when the first outer component is displaced in vertical translation, for said first inner component and the rod control stem to follow a displacement in said vertical translation,
said motor compartment comprising first motorized mechanical means for transmitting vertical translational displacements of said first outer component of said first magnetic coupling system.

It will be understood that said first outer and inner components are arranged facing one another on either side of the side wall of the sealed confinement chamber with an air gap allowing their magnetic linkage.

The term “soft ferromagnetic element” here refers to the magnetic properties, namely that the main property of this material is that it magnetizes easily and quickly loses its magnetization capacity once it is no longer subject to a magnetic field, unlike hard magnetic materials which do not demagnetize, particularly those made of rare earths, such as Neodymium.

In an embodiment, the two said first inner and said first outer components each comprise alternating permanent magnets separated by soft ferromagnetic elements. This configuration makes it possible to increase the coupling power and reduce the dimensions of the coupling.

More particularly, said upper motor compartment encloses a first motor, preferably of geared motor type, cooperating with first mechanical means for transmitting displacement by contact comprising a first gear train and at least one planetary roller screw or one ball screw.

Said sealed static confinement chamber of the device according to the invention makes it possible to confine the mechanically aggressive environment of the sodium aerosols coming from the vat inside said chamber and to insulate without risk of leaks the mechanical parts in relative movement by contact with the movement transmission chain, outside said chamber. This is made possible by implementing a said magnetic coupling for transmitting movement to the rod control stem acting through the wall of the sealed chamber.

The benefit of the invention lies in the possibility of protecting the chain of mechanical transmission by contact, by placing it outside the aggressive environment of the sodium aerosols while guaranteeing the transmission of a mechanical movement to a single component (here, the rod control stem) located in the aggressive environment. In practice, the invention makes it possible to eliminate failures to the sodium aerosols recorded on existing devices. The fact of no longer having any parts in relative movement with one another by low mechanical clearances in the presence of sodium aerosols causes the risk of wear and blockage by friction to disappear.

Furthermore, due to the fact that all the components in mechanical relative displacements of the mechanical transmission chain by contact are outside the sodium aerosol environment, the chemical and nuclear hazards are thereby reduced for operators in a maintenance situation, the need for nuclear and chemical decontamination being limited to the rod control stem. This ability offered by magnetic coupling technologies to interact mechanically with a component in an aggressive medium through a sealed wall/chamber, is therefore particularly advantageous in the nuclear sector, which is further seeking to limit the propagation of any nuclear contamination.

The benefit of magnetic couplings, contactless and therefore wearless, is also to considerably reduce maintenance operation times for the device, which increases the availability thereof.

The confinement chamber makes the activating of the gripping by a control stem of the gripper translationally controlled through the wall of the confinement chamber in a manner that is differentiated from the rod control stem. Moreover, the holding of a control stem of the gripper would make a risk of sodium aerosols being present in the gaps between two rods persist. These considerations have led to the conclusion that the invention entails a new type of gripper actuated by a second magnetic coupling acting through the cob, by rotating a guide shaft inserted into the upper part of the rod control stem.

Preferably, the rod handling device according to the invention further comprises:
a said upper motor compartment comprising second motorized mechanical means for transmitting rotational displacements of said rod control stem along its longitudinal axis; and
a said gripper able to be actuated to seize or respectively release the end of said control rod by rotation of said rod control stem along its longitudinal axis.

With the disappearance of the clamp control stem of the existing rod handling devices, the mechanical gaps of parts in contact in relative movement inside said chamber disappear and no longer give rise to the threat of aerosol deposits that would cause mechanical blockages.

More particularly, said gripper at the lower end of said control stem forms a grab comprising a plurality of fingers arranged in the direction of the axis of the rod control stem in the retracted position and able to pivot or bend to move angularly away from the axis of the rod control stem and/or expand radially, reversibly, under the action of axial rotation of the rod control stem, to cooperate with the upper part of the absorbent rod and block itself there to seize the absorbent rod.

More particularly, said gripper comprises at least two parts cooperating with one another in a helical connection by screwing with:
a first threaded part integral with the end of the rod control stem, said first fixed part comprising downstream of its threaded part, an area with a widened cross section diameter, and
a second tapped part able to be translationally displaced with respect to said first threaded part by screwing one with respect to the other,
said second tapped part bearing said flexible fingers which move apart radially when they encounter said area of widened diameter of said first part due to the relative translation of the two said threaded and tapped parts by relative screwing resulting from the rotation of the rod control stem driving the relative rotation of the first threaded part with respect to the second tapped part.

Preferably, the device comprises a second stem known as the guide shaft, inserted into a center cavity of the upper part of said rod control stem, preferably in the longitudinal axis of the side wall of revolution of said sealed confinement chamber, said control stem being able to slide with respect to said guide shaft when it is translationally actuated by said first magnetic coupling system, said guide shaft being blocked in vertical translation and able to be rotationally driven about its longitudinal axis (XX′), said guide shaft being able to cooperate with said center cavity so that the rotation of the guide shaft about its longitudinal axis (XX′) drives the rotation of the rod control stem about its longitudinal axis (XX′).

Thus, the rotation of the rod control stem results from the rotation of the guide shaft.

More particularly, it is the shape of the cross section of the guide shaft that cooperates with that of the center cavity of the upper part of said rod control stem and which provides at once a sliding connection (displacement along the axis of the guide shaft) and a pivot connection (rotation about the axis of the guide shaft), allowing the control stem to move in relative linear displacement with respect to the guide shaft and allowing the control stem to simultaneously rotate with the guide shaft, i.e. a sliding pivot connection, and this independently of the relative position of the magnetic coupling in translation vis-à-vis the guide shaft.

Also preferably, the rod handling device according to the invention further comprises:
a second synchronous magnetic coupling system for transmitting rotational movement without mechanical contact comprising:
a second inner component comprising at least one soft ferromagnetic element, arranged inside said sealed confinement chamber, fixed in vertical translation, able to be rotationally displaced along the longitudinal axis of said chamber, integral with said guide shaft, fixed in vertical translation, and
a second outer component comprising a block of permanent magnet(s), preferably consisting of alternating permanent magnets separated by soft ferromagnetic elements, said block being arranged inside said motor compartment outside said sealed confinement chamber, and able to be rotationally displaced along the longitudinal axis of the side wall of revolution of the sealed confinement chamber, and the magnetic coupling force of said second outer component and said second inner component making it possible, when said second outer component is rotationally displaced, for said second inner component, said guide shaft and the rod control stem to follow a same displacement in said rotation along their same longitudinal axis,
said upper motor compartment comprising second motorized mechanical means for transmitting said rotational displacements of said second outer component along the longitudinal axis of the side wall of revolution of the sealed confinement chamber, said upper compartment preferably enclosing mechanical means for transmitting rotational displacement of pinion gear type.

More particularly, the two said inner and outer components are translationally fixed.

It will be understood that said second outer and inner components are arranged facing one another on either side of the wall of the sealed confinement chamber with a reduced air gap and coaxially with respect to the longitudinal axis of said side wall of revolution of the sealed confinement chamber.

Synchronous magnetic coupling systems are known to those skilled in the art. This technology puts into application the principle of magnetic attraction, i.e. the existence of a holding force related to the intensity of the magnetic induction of a magnetic field developed by a permanent magnet. The inductive part consisting of a permanent magnet on one side of the non-magnetic wall generates field lines which then close on the induced part consisting of a metal part of the soft ferromagnetic element on the other side of the non-magnetic wall. Magnetic coupling technology makes it possible to transmit movements without contact through a non-magnetic wall as long as the air gap between the permanent magnet and the ferromagnetic element remains small. Magnetic couplings can be used for driving in linear translation or driving in rotation. The two elements separated by the non-magnetic sealed shroud are also known as the “driving” or “inductive” part for the part on which the permanent magnets are installed and the “driven” or “induced” part for the magnetically linked part.

More particularly, the first magnetic coupling system for transmitting linear translational movement comprises:
a first outer component consisting of a magnet coaxially arranged with said side wall of revolution of the chamber, in the form of a stack of permanent magnet rings, preferably made of a neodymium-iron-boron alloy, separated by rings of soft iron plates, and
a first outer component coaxially arranged with said side wall of revolution of the chamber and consisting of at least a stack of soft iron rings fastened to the upper part of the control stem.

Permanent magnet rings and soft iron elements can be distributed in an alternating pattern over the two inner and outer components. This arrangement makes it possible to increase the coupling power and to reduce the dimensions of the coupling.

Similarly, the second magnetic coupling system for transmitting rotational movement comprises:
a second outer component consisting of an annular block of permanent magnet coaxially arranged with said side wall of revolution of the chamber, preferably a neodymium-iron-boron rare earth alloy, and
a second inner component consisting of at least an soft iron element fastened to the upper part of said guide shaft coaxially arranged with said side wall of revolution of the chamber.

In a known manner, the term “soft iron” refers to both iron and soft steel.

More particularly, the second magnetic coupling system for transmitting rotational movement comprises:
a second outer component consisting of an assembly of permanent magnets separated by soft iron elements arranged side-by-side at a same radial distance from said side wall of revolution of the chamber, the outline of each of said elements each having a shape of a circular arc section, preferably the same circular arc section, and
a second inner component consisting of an assembly of soft iron elements arranged side-by-side at the same radial distance from the longitudinal axis (XX′) of the upper part of said guide shaft, the outline of each of said elements each having a shape of the same cross section of an arc of circle, preferably the same cross section of an arc of circle.

Preferably, the rod handling device according to the invention further comprises a device for emergency shutdown of the reactor comprising a component known as a magnetic suction cup comprising a permanent magnet combined with an electromagnetic coil inside said upper motor compartment outside said sealed confinement chamber so that:
said suction cup is integral with a suction cup base, said upper motor compartment comprising first motorized mechanical means for transmitting control for translational displacements of said suction cup base;
the electrical activation of said electromagnetic coil modifies the magnetic field generated by the magnet of said magnetic suction cup which closes on a metal part of said first outer component of the first magnetic coupling system and creates a link by magnetic bonding between said suction cup and the first outer component of the first magnetic coupling system thus providing the translational displacement of said first outer component by displacement of said suction cup base, and
the absence of electrical activation of said electromagnetic coil re-establishes the magnetic field of the magnet of said magnetic suction cup which field is no longer directed onto a metal part of the first outer component of the first magnetic coupling system and thus permits the gravitational fall of said first magnetic coupling system and therefore the gravitational fall of said absorbent rod when the latter is seized by said gripper at the lower end of the rod control stem.

The magnetic suction cup has the peculiarity of including an electromagnetic coil, not to produce the magnetic bonding force as in the prior art, but to modify the orientation of the magnetic flux generated by a permanent magnet. Thus the magnetic suction cup has 2 states—ON and OFF—which are the consequence of the supply of power or otherwise to the electromagnetic coil. If the electromagnetic coil is active, the field generated by the inductor permanent magnet closes on a metal part of the movable assembly to be supported formed by the set of components driven in axial displacement for the holding of the absorbent rod including the rod control stem, the gripper and the absorbent control rod. Conversely, the magnetic field of the inductor is directed onto another part of the mechanism to cancel the hold and cause the rod to be dropped.

This magnetic suction cup further makes it possible to implement a less powerful electromagnetic coil than in the prior art, wherein only an electromagnetic coil (not coupled to a magnet) provided the device for automatic shutdown of the reactor. This assembly further makes it possible for the movable part in gravitational fall upon deactivation of the electromagnetic coil to be relatively simplified, since the transmission means controlling the translational displacements of said suction cup base are not caused to fall also, but remain fixed.

The absorption of the falling energy of the movable part of the mechanism in the event of a request for emergency shutdown of the reactor is effected in the present invention by a Foucault current magnetic damper.

Also preferably, the rod handling device according to the invention comprises a fall damping device constituting a magnetic damper comprising a first damper element consisting of a permanent magnet able to slide in relative displacement facing a second damper element made of materials of low electrical resistance, preferably copper, arranged under the first damper element, the relative displacement of said first damper element with respect to said second damper element occurring when a device for automatic shutdown of the reactor permits the gravitational fall of said absorbent rod.

The magnetic field of the first damper element in relative displacement with respect to the second damper element is thus able to induce a Foucault current, the latter generating a Laplace force opposing said relative displacement of the first damper element with respect to the second damper element.

The principle of magnetic braking is known to those skilled in the art as resulting from the variation of a magnetic flux, initially constant, modified by the relative displacement of a magnetic ground and a ground of low electrical resistance, the magnetic field of the magnetic ground (first damper element) in relative displacement with respect to the ground of low electrical resistance (second damper element) being able to induce an electromotive force in the ground of low electrical resistance (second damper element) generating in turn a Foucault current, the latter generating a magnetic field and a Laplace force opposing said relative displacement of the magnetic ground (first damper element) with respect to the ground of low electrical resistance (second damper element).

More particularly, the fall damper device constituting a magnetic damper comprises:
a second damper element in the shape of a ferrule, fixed, coaxially arranged in the bottom part of said upper compartment outside said chamber, and
a first damper element consisting of a permanent magnet coaxially fastened to said first outer component of said first magnetic coupling system, able to slide coaxially inside said ferrule-shaped second damper element in the annular space between said ferrule and the cylindrical side wall of said chamber, when said device for automatic shutdown of the reactor permits the release of said first outer component of said first magnetic coupling system.

Here the conductive ground, in the shape of a copper ferrule, is fastened to the bottom part of the upper compartment outside the confinement shroud and forms the inductee of the damper. The magnetic ground, preferably a permanent magnet made of a rare earth alloy (neodymium-iron-boron) is the inductor part which creates the constant magnetic field and which moves in front of the inductee.

In this embodiment, the inductor is placed on the movable equipment. In another configuration, it can be separate and placed attached and near the inductee to form a single same part together. In the latter case, the movable assembly strikes the inductor during its fall and causes its relative displacement with respect to the inductee.

This magnetic damper device advantageously replaces the gas damper devices operating on the principle of a piston compressing a volume of gas pushed toward a calibrated outlet. Specifically, the Foucault current magnetic damper according to the invention has the benefit of considerably simplifying the number of mechanical parts involved. Here we go from a mechanism of pneumatic piston type, to a system of two elements (a magnetic inductor of permanent magnet type, and a material of low electrical resistance) assembled in such a way as to slide one inside the other. But the most important benefit is that the damper remains constantly operational, without requiring activation. It is the speed of the fall of the inductor present on the movable assembly in gravitational fall that generates the braking force. This braking force is intrinsic to the displacement of the inductor. Such a device can be described as a passive operating device because it does not depend on any outer condition which is greatly appreciated with respect to the rules of nuclear safety.

The present invention therefore also provides a method for handling an absorbent rod used to control the neutron flow emitted by the fuel assemblies of a nuclear reactor, preferably of the sodium-cooled fast-neutron reactor type (FNR-Na), by relative translation of an absorbent rod with respect to its sheath arranged between fuel rods using a handling device according to the invention.

More particularly, the reactor is automatically stopped by free gravitational fall of the rod control stem and of the absorbent rod that is fastened thereto by said gripper, by cutting the electrical power supply of a said magnetic suction cup and preferably a magnetic damper device as defined below. Other features and advantages of the present invention will become more apparent on reading the following description, given for the purposes of illustration and non-limiting, with reference to the following appended drawings.

### BRIEF DESCRIPTION OF THE FIGURES

FIG. 1 is a schematic vertical section view of an absorbent rod handling device of an FNR reactor of the prior art;

FIG. 1A is a schematic vertical section view of a device for handling absorbent control rods according to the present invention placed in a reactor vat 13 containing an absorbent rod 11 positioned between two fuel assemblies 14 for illustration purposes,

FIG. 1B is a schematic vertical section view of a device for handling absorbent control rods according to the present invention explaining the means for transmitting mechanical movements by contact inside the upper motor compartment 2,

FIG. 2 is a view showing the various separate components participating in the translation of the control stem 3 including the first synchronous magnetic coupling system 6a along with the automatic shutdown device of magnetic suction cup type 8,

FIG. 3 is a view showing the various components participating in the function of controlling the seizing of the absorbent rod 11 by the handling device according to the present invention including the second synchronous magnetic coupling system 6b,

FIGS. 4A and 4B are median vertical section views (FIG. 4A) and a cross-section top view (FIG. 4B) showing the various elements of the second synchronous magnetic coupling system 6b assembled to control the rotation of the guide shaft 7 inside the sealed confinement chamber 5,

FIGS. 5A and 5B show the various components participating in the function of automatic release of the control stem 3 for the automatic shutdown of the reactor comprising the various components of a magnetic damper 9 separated (FIG. 5A) and assembled in normal operating mode (FIG. 5B) and in automatic reactor shutdown mode after a gravitational fall (FIG. 5C),

FIG. 6 shows the various parts of a gripping device according to the invention,

FIGS. 6A and 6B show the gripping device 4 of FIG. 6 with its gripping fingers 4a in the retracted position wherein the upper part 11a of the absorbent rod 11 is not seized (FIG. 6A) and in the expansion position wherein the upper part 11a of the absorbent rod 11 is seized in the blocking position by the gripping device 4 (FIG. 6B),

FIG. 7 shows a magnetic suction cup 8 according to the present invention, and

FIGS. 8A to 8C represent various relative positions of the control stem 3 and the gripping device 4 with respect to the absorbent control rod 11.

### MORE DETAILED DESCRIPTION

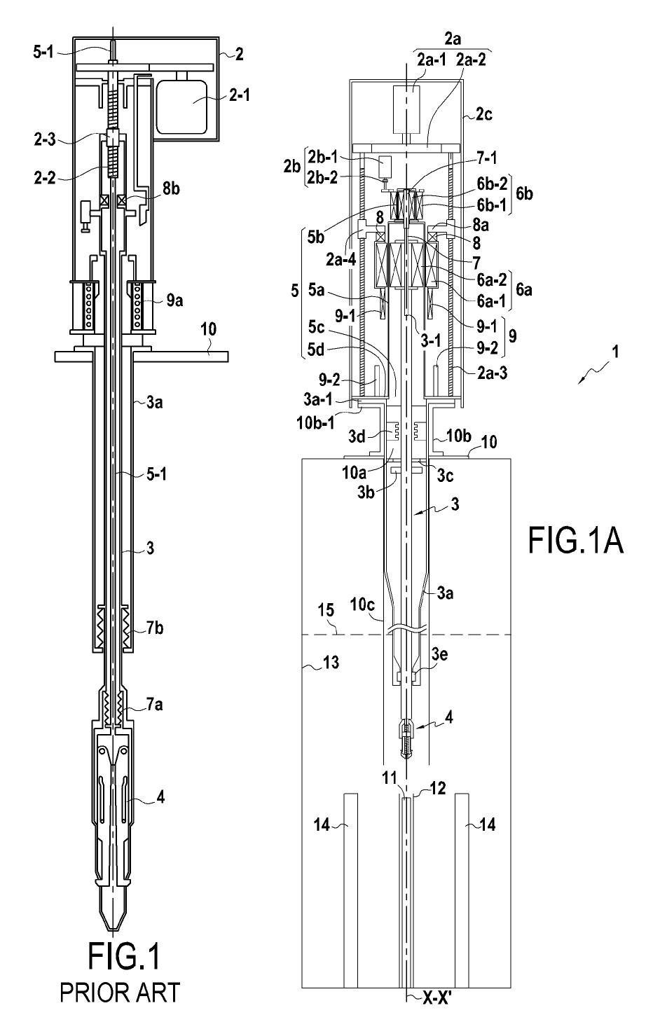

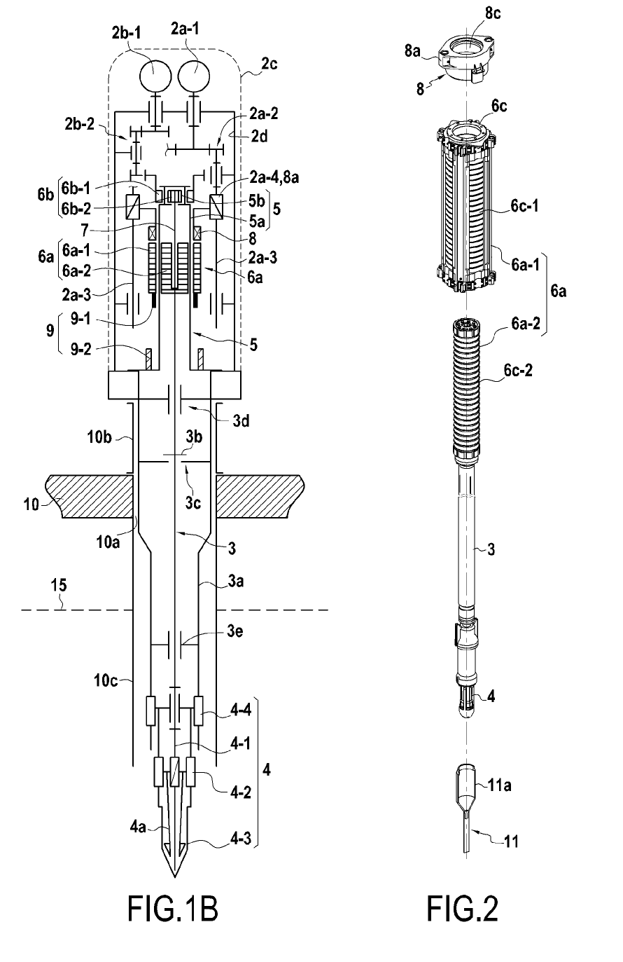

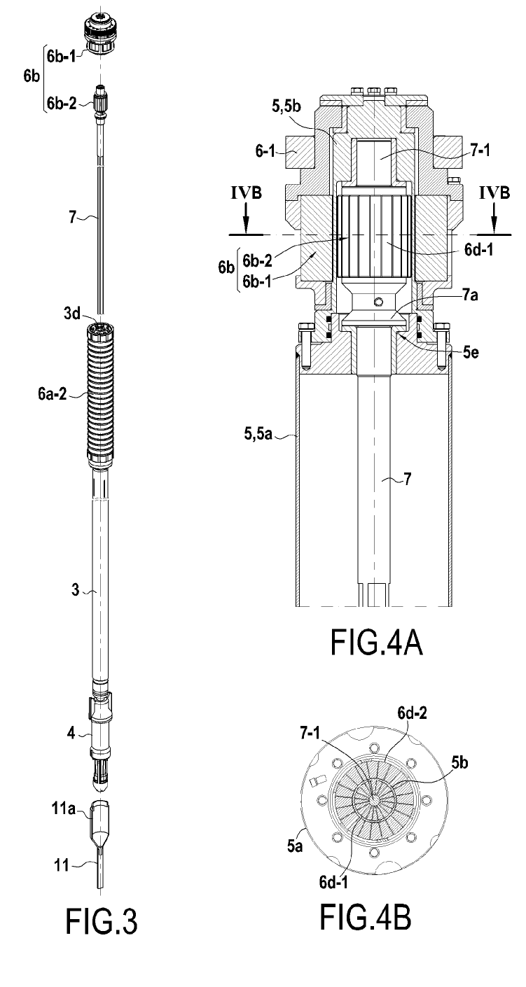

FIG. 1A schematically represents a device 1 for handling a control rod according to the present invention, arranged on the closing slab 10 of a reactor vat 13 in which are shown only two fuel assemblies 14 with an absorbent control rod 11 in its cylindrical housing 12 on the floor of the vat. The rod control handling device 1, according to the present invention, has a vertical longitudinal axis XX′ arranged in the longitudinal axis of the rod housing or sheath 12.

The rod control handling device 1 comprises a rod control stem 3 arranged in the vertical longitudinal axis XX′ inside a guide sheath 3a comprising cylindrical cross sections extending inside said vat, above the housing 12 of the absorbent rod 11.

The rod control stem 3 comprises a gripping device 4 in the form of a grab at the lower end of the control stem 3 able to seize the upper end 11a of the absorbent rod 11.

The handling device 1 comprises means for vertically translating the rod control stem 3 described hereinafter. The vertical translation of the control rod 3 is designed to allow the insertion and extraction of the control rod 11 with respect to its housing 12 when the upper end 11a of the control rod 11 is seized by the gripping device 4.

The guide sheath 3a is surmounted by a fastening flange 3a-1 around its open upper end, said flange 3a-1 allowing it to be fastened to the upper flange 10b-1 of a fastening sleeve 10b resting on the slab 10 around a cavity 10a of the closing slab 10 of the reactor vat 13, said cavity 10a being crossed by the guide sheath 3a.

An upper compartment 2 is arranged on the slab 10 covering said cavity 10a and the guide sheath 3a, this upper compartment 2 encloses a sealed static confinement chamber 5 made of a non-magnetic material such as stainless steel of 316L type, shroud-shaped and comprising a side wall of revolution with cylindrical walls 5a and 5b of the same axis of rotating as the longitudinal axis XX′ of the upper compartment 2 and of the guide sheath 3a. The sealed confinement shroud 5 is open at its base 5c at the level of the upper opening of the guide sheath and facing the opening 10a of the cavity inside the closing slab 10. The shroud 5 comprises a peripheral flange 5d at its lower end, around its open base 5c, used to make a sealed fastening on the upper fastening flange 3a-1 of the guide sheath 3a. The upper compartment 2 is delimited by a wall constituting a casing 2c, closed at its lower end by the upper fastening flange 3a-1 of said guide sheath 3a and/or the lower flange 5d of the shroud 5 and/or the upper fastening flange 10b-1 of the sleeve 10b. The seal of the fastening of the shroud over the closing slab 10 is done using O-rings. It makes it possible to insulate the environment of the area of the compartment 2 outside the shroud 5 from the inner atmosphere of the shroud 5.

The upper part of the rod control stem 3 contained in the shroud 5 includes a center cavity 3-1 inside which a stem known as the guide shaft 7 extends. The upper part 7-1 of the guide shaft is integral with the inner component of the second magnetic coupling 6-b2 (described hereinafter) inside an upper part of the shroud 5 with cylindrical wall 5b of smaller diameter above the rod control stem 3. The guide shaft 7 comprises in its upper part 7-1 above the cavity 3-1 a projecting part or bulge 7a (FIG. 4A) cooperating with a guide bearing 5e of the cylindrical wall of the shroud 5 in such a way as to keep the guide shaft at a constant height and permitting only one rotation of the guide shaft 7 about its longitudinal axis XX′. Said center cavity 3-1 of the upper part of the control stem 3 extends over a height sufficient to allow the sliding of the control stem 3 along the guide shaft 7 allowing the insertion or extraction of the control rod 11 from its housing 12 to control the reactivity of the reactor. In practice, this distance of travel of the control rod 11 between the shutdown of the reactor when the rod 11 is entirely inserted inside this housing 12 and the partial extraction of the rod 11 out of the housing 12 and above the latter corresponds, in the absorbent rod, to the height of the part containing the radioactive material (known as the fissile area.)

The actuation upon opening and closing of the gripping device 4 to seize and release the upper end 11a of the rod 11 respectively, is done by rotation of the rod control stem 3 along its vertical longitudinal axis XX′ in one direction and in the other direction respectively

The cooperating between the guide shaft 7 and the cavity 3-1 of the stem 3 is in a sliding pivot connection. To achieve this, the guide shaft 7 has a square cross-section in the same way as the cross section of the center cavity of the upper part of the control stem 3 into which the guide shaft 7 is inserted in such a way that the rotation of the guide shaft 7 along its vertical longitudinal axis XX′ drives the rotation of the rod control stem 3.

The upper compartment 2 encloses two synchronous magnetic coupling systems 6a and 6b. The first synchronous magnetic coupling system 6a is able to transmit a movement of vertical linear translation to the rod control stem 3. The second synchronous magnetic coupling system 6b is able to transmit a movement of axial rotation along the vertical longitudinal axis XX′ of the device to the guide shaft 7.

The first synchronous magnetic coupling system 6a comprises a first outer component 6a-1 comprising a first block of permanent magnets constituting the “inductor” part or “driving” part of the first magnetic coupling system. This block of permanent magnets consists of a coaxial stack of rings 6c-1 (FIG. 2) comprising rings of permanent magnets made of neodymium-iron-boron, separated by rings of soft iron plates constituting a block of permanent magnets that is perforated axially as shown in FIG. 2. Said rings 6c-1 are crossed by, and coaxially surround, the main cylindrical wall 5a of the sealed shroud 5 and are able to be vertically translated along and around said cylindrical wall 5a.

The first synchronous magnetic coupling system 6a comprises a fist inner component 6a-2 constituting the “driven” or “induced” part also consisting of a stack of soft iron rings 6c-2 constituting a block 6a-2 axially perforated, fastened to and around the upper part of the rod control stem 3 coaxially arranged in and crossing the axial perforation of said block 6a-2 of the stack of soft iron rings.

The first outer component 6a-1 and the first inner component 6a-2 are coaxially arranged at the same height, facing one another on either side of the cylindrical wall 5a of the sealed shroud 5 with a reduced air gap and are magnetically linked, so that when the driving part 6a-1 is displaced in vertical translation, the driven part 6a-2 follows this translational movement.

Due to the fact that the first inner component 6a-2, bears the load of the rod control stem 3 and, where applicable, of the absorbent control bar 11, an axial offset can be observed proportional to the mass of the load borne according to the stiffness of the coupling. But the dimensioning of the magnetic coupling is done so that this offset remains minimal and in the linear part of the curve of offset with respect to the load, and does not modify the stiffness of the coupling, in a manner known to those skilled in the art.

More particularly, the load is in the order of 300 to 400 kg for the movable equipment formed by the set of components driven in axial displacement for the handling of the absorbent rod including the rod control stem 3, the gripper 4 and the absorbent control rod 11. All these elements of the movable equipment are translated over a height of approximately 1 meter corresponding to the height of elevation of the absorbent rod 11 for the management of the reactor core.

In practice, the stacks of rings of magnet and soft iron of the block 6a-1 make it possible to produce a magnetic coupling over a coupling height of approximately 600 mm sufficient to obtain an offset stiffness of +/−0.5 mm to +/−1 mm with an air gap of 6 to 7 mm for a magnetic wall of 4 to 5 mm and therefore distances between the wall 5a and the first outer component 6a-1 and the first inner component 6a-2 respectively, less than 1 mm.

The displacement in vertical translation of the first outer component 6a-1 and the first synchronous magnetic coupling system 6a is done using first motorized means 2a comprising a first motor 2a-1 cooperating with mechanical elements for transmitting movement by contact comprising a gear train 2a-2 comprising two planetary roller screws 2a-3 controlling the displacement in vertical translation of a nut 2a-4 integral with a metal support 8a. The two nuts 2a-4 of the systems of two roller screws 2a-3 therefore are integral with the plate 8a supporting the suction cup 8. A “planetary roller screw” is a mechanism known to those skilled in the art providing the conversion of a rotational movement of a screw resulting from the first gear train into a translational movement of a screw by a threaded helical connection of said screw and said nut.

The element known as the magnetic suction cup 8 generates an attractive force which links it magnetically to the first outer component 6a-1 notably to the upper closing plate 6c (FIGS. 2) of the stack of rings 6c-1 of the block of permanent magnets of the first outer component 6a-1.

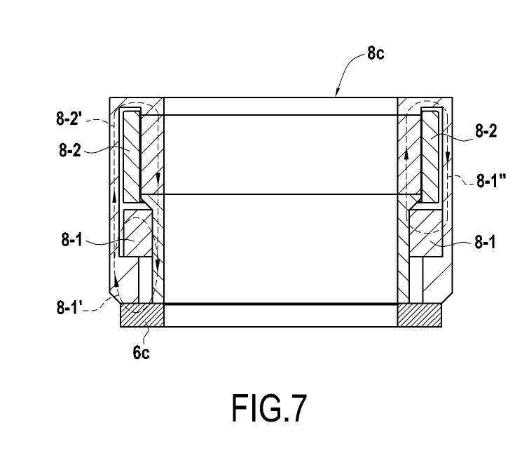

As represented in FIG. 7, the magnetic suction cup 8 comprises a permanent magnet 8-1 which generates a magnetic flux that guarantees its magnetic bonding with the stainless steel part 6c of the upper end of the first outer component 6a-1. The magnetic suction cup 8 has a same annular shape with an axial perforation 8c coaxially arranged with respect to said first outer component 6a-1 to be arranged around the cylindrical wall 5a of the shroud 5 facing the ring-shaped upper part 6c of the first outer component 6a-1.

The magnetic suction cup 8 is a device allowing the automatic emergency shutdown of the reactor by triggering the electrical activation of an electromagnetic coil 8-2 coupled with said permanent magnet 8-1. The electromagnetic coil 8-2 associated with the permanent magnet 8-1 has the function of modifying the orientation of the magnetic field produced by the permanent magnet 8-1 as follows. When the electromagnetic coil 8-2 is powered by an electrical current, the magnetic flux 8-2′ of the electromagnetic coil 8-2 thus generated serves to modify the magnetic flux 8-1′ which holds the permanent magnet 8-1 bonded to the metal plate 6c of the upper end of the first outer component 6a-1 which part 6c thus undergoes the considerable attractive force of the magnet 8-1. When the electromagnetic coil 8-2 is no longer powered with electrical current, the magnetic flux generated by the permanent magnet 8-1 which takes a direction 8-1″ which no longer goes by the plate 6c which causes the release of the first outer component 6a-1. To avoid a phenomenon of bonding by magnetic remanence between the magnet 8-1 and the plate 6c, spring ejectors can be added between the suction cup 8 and the closing pate 6c. It is important to place an air gap in the order of the millimeter between the magnet 8-1 and the plate 6c.

The magnetic suction cup 8 is therefore compliant with the requirements of nuclear safety, which requires the automatic shutdown mechanism of the reactor to be triggered in the event of a cut-off in the electrical power supply.

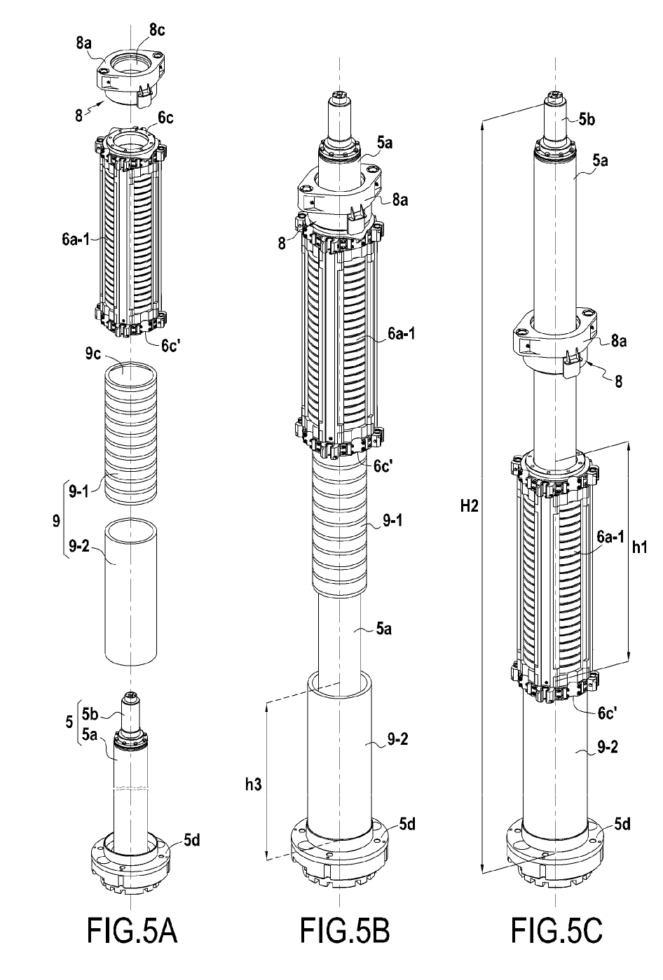

The magnetic suction cup 8 for the automatic shutdown of the reactor cooperates with a magnetic damping device 9, the structure and operation of which are explained hereinafter. The handling device 1 according to the present invention, comprises a magnetic fall absorber device 9 composed, as shown in FIGS. 5A to 5C:
of an inductor block 9-1 formed of a stack of permanent neodymium-iron-boron magnets integral with a metal part 6c′ (FIGS. 5A-5C) and the lower end of the first outer component 6a-1 of the first magnetic coupling system 6a having a hollow tubular shape, the central perforation 9c of which is crossed by said cylindrical wall 5a of the sealing shroud 5, and
of an induced part 9-2 in the form of a copper ferrule of wider diameter than the tubular block 9-1, coaxially arranged with the longitudinal axis XX′ and fastened to the lower flange 5d of the sealing shroud 5.

If the first outer component falls when it is released by deactivation of the magnetic suction cup 8 as described above, the magnetized block 9-1 of the magnetic damper placed under the first outer component 6a-1 of the first linear coupling system is found in relative coaxial displacement art to and inside the induced fixed inner element 9-2.

The relative displacement of the magnetic ground 9-1 with respect to the ground of low electrical resistance 9-2 gives rise, due to the variation of the magnetic flux, in a known manner, to Laplace forces which oppose said relative displacement, the effectiveness of the braking by slowing down of the magnetic part 9-1 in fall being proportional to its coaxial displacement speed with respect to the induced metal part 9-2.

In practice, in the configuration of the device according to the present invention, upon deactivation of the magnetic lock 8 to create the fall of the first outer component 6a-1 and of the elements of the movable equipment that are magnetically linked to it, the penetration of the permanent magnet element 9-1 of the magnetic damper into the area of influence of the conductive element 9-2 generates sufficient braking to minimize the impact of the mechanical end stop of the lower end of the magnet block 9-1 against the lower peripheral flange 5d at the base of the shroud 5 and inside the ferrule 9-2.

In practice, the copper ferrule 9-2 extends over a height h3 of approximately 600 mm. The final speed of the movable equipment before shutdown on the mechanical end stop is of approximately 0.2 m/s. The maximum outer diameter of the cylindrical wall 5a of the shroud 5 is of approximately 150 mm. The inner diameter of the copper ferrule 9-2 is of approximately 200-250 mm. As represented in FIG. 5C after the fall of the movable equipment of all the components 6a-1 and 9-1, the lower end 6c′ of the first outer component 6a-1 arrives just above the upper end of the copper ferrule 9-2 after insertion of the magnetized inductor part 9-1 in the annular space between the cylindrical wall 5a and the copper ferrule 9-2.

The second synchronous magnetic coupling system 6b controls the rotation of the guide rod 7 along its longitudinal axis XX′ driving the simultaneous rotation of the rod control stem 3 with respect to its longitudinal axis XX′ due to their sliding connection in relative anti-rotation described above.

The second synchronous magnetic coupling system 6b comprises, as shown in FIGS. 4A and 4B:
a second inner component 6b-2 with a circular cross-section consisting of an assembly of soft iron elements side-by-side at a same radial distance from the longitudinal axis XX′ coaxially fastened against the upper part 7-1 of the guide rod 7, inside the shroud 5, at the level of an upper compartment with a cylindrical wall 5b of smaller diameter than the main cylindrical wall 5a, the contour of each of said elements each having a shape 6d-2 of a same circular arc section, preferably the same circular arc section, and
a second outer component 6b-1 coaxially arranged outside and facing the upper cylindrical wall 5b of the sealing shroud 5 and facing a second inner component 6b-2, said second outer component 6b-1 consisting of a stack of permanent magnet elements made of neodymium-iron-boron separated by soft iron elements arranged side-by-side at a same radial distance from said suide wall of revolution 5b of the chamber, the outline of each of said elements each having a shape 6d-1 of circular arc section, preferable the same circular arc section.

Said second outer component 6b-1 is mounted to be able to be mechanically driven in rotation along its axis XX′ due to the fact that it is integral with a pinion 6-1 rotationally driven by the pinion gearing of the second gear train 2b-2 actuated by a second motor 2b-1. The set of second motorized rotation means 2b, 2b-1, 2b-2 are located in the upper compartment 2 outside the sealing shroud 5.

Thus configured, the second rotational coupling system 6b is not part of the movable equipment in gravitational fall upon the automatic shutdown of the reactor by deactivation of the magnetic suction cup 8.

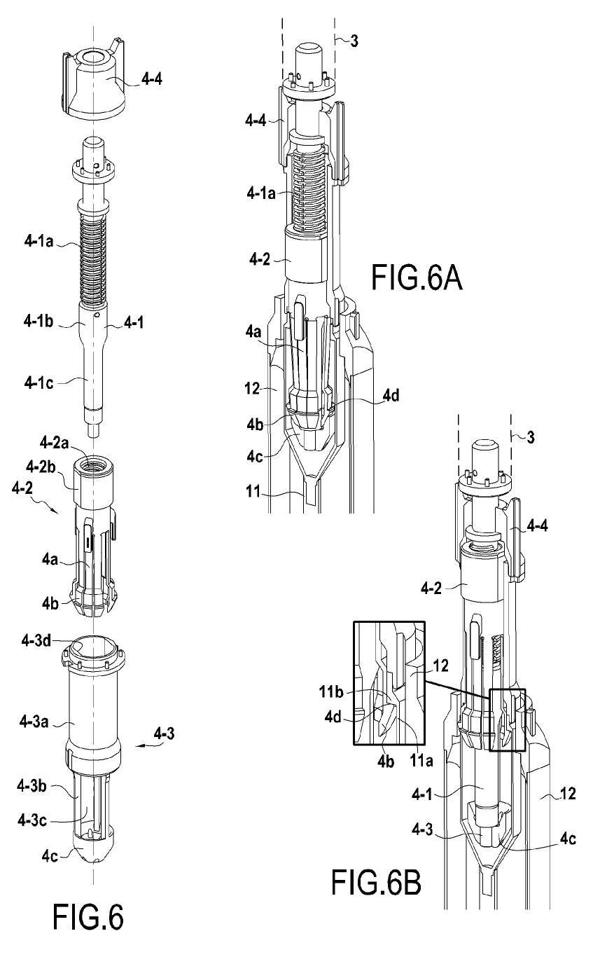

The gripping device 4 fastened at the lower end of the rod control stem 3 is actuatable upon opening and closing to seize and release the upper end 11a of the absorbent control rod 11, by rotation of the rod control stem 3. It is the result of the actuation of the second rotational coupling system 6b. More precisely, as shown in FIG. 6, the gripping device 4 comprises a first element 4-1 fastened to the lower end of the rod control stem 3 including a threaded male part 4-1a and a non-threaded lower part, arranged under the threading 4-1a, including a part of greater diameter 4-1b and a lower end part of smaller diameter 4-1c. The first part 4-1 of the gripper 4 is able to cooperate by screwing with a second part 4-2 including a tapping 4-2a. The second part 4-2 bears a plurality of longitudinal fingers 4a regularly distributed around the longitudinal axis XX′ of the rod control stem 3 when the gripper is mounted at its lower end, by screwing the second part 4-2 at the threading 4-1a of the first part 4-1. The actuation of the rotation of the rod control stem 3 drives the rotation of the first part 4-1 of the gripper 4 which makes it possible, according to the direction of rotation, to vertically translated or raise the female part 4-2, the tapping 4-2a of which cooperates with the threading 4-1a of the first part 4-1.

The fingers 4a each including a lower end of lug type formed by a shoulder turned outward 4b. The flexible fingers 4a are kept in the retracted position as close as possible to the area of reduce diameter 4-1c by a lower end stop surface of a lower part 4c of a third part 4-3 coaxially covering the second part 4-2. This part 4-3 includes a tubular upper part 4-3a, a conically-shaped lower part 4c and intermediate longitudinal connecting elements providing the connection between the parts 4-3a and 4c. Open areas 4-3c between the longitudinal elements 4-3b permit the radial expansion of the fingers 4a.

Two lands positioned, one 4-2b on the part 4-2, the other 4-3d on the part 4-3 are used for rotational blocking 4-2 during translation and thus transform the helical connection into a sliding connection.

The flexible fingers 4a are kept in a retracted position by said end stop surface of the part 4c when the female part 4-2 is positioned in its lowest position with respect to the first part 4-1 at the threading 4-1a.

The relative rotation of the part 4-1 with respect to the part 4-2 in one direction drives the ascension of the part 4-2 toward the upper end of the threading 4-1a which makes it possible to disengage the lugs 4b retained by the end stop surface 4c and to move the fingers 4a apart from one another by radial expansion when the lugs 4b encounter the surface of expanded diameter 4-1b of the first part 4-1.

An upper part 4-4 of the gripping device is integral with the upper end of the upper part of the part 4-3. This part 4-4 includes a shape able to cooperate with notches at the lower end of the guide sheath 3a in such a way as to prevent the relative rotation of the part 4-3 with respect to the stem 3.

To seize the control rod 11, the gripper 4 is inserted in the retracted position in the upper cavity 11a of the control rod 11; then, the rod control stem 3 is rotated in such a way as to generate the rotation of the part 4-1 with respect to the part 4-2 which being in helical connection with the part 4-1 is displaced in vertical translation upward in such a way that:
the lugs 4b and fingers 4a are no longer bearing against the bearing surface 4c of the lower body 4-3 of the gripper 4 and relax in radial expansion to regain their original shapes, being no longer restrained in the retracted position, and
by rising back up into the inner housing 11a at the upper end of the control rods 11, the lugs 4b present an outer face 4d which then cooperates with a peripheral end stop surface 11b of the inner housing 11a which, by rotation of the rod control stem 3, blocks the gripper 4 inside the cavity 11a of the upper part of the control rod 11 as shown in FIG. 6B.

To detach the gripper 4 from the control rod 11, a rotation occurs in the reverse direction which has the effect of bringing the part 4-2 back down and disengaging the lugs 4b thereof from the bearing surface 11b of the control rod 11. The rotation of the control stem 3 driving the descent of the part 4-2 is effected until the lugs 4b are once again cooperating with the end stop surfaces 4c of the lower part 4-3 and are kept in the retracted position, then making it possible to disengage the gripper 4 from the upper housing 11a from the control rod 11 by ascending vertical translation thereof using the first synchronous coupling system by translation 6a.

The fingers 4a of the gripper 4 are flexible at the upper part on the outer part 4-2 and the set of lugs 4b at the lower ends of the fingers 4a have a conically-shaped outer surface cooperating with a conic additional surface 4c of the part 4-3.

The guide sheath 3a includes a guide bearing 3c able to cooperate with a locking device 3b of bayonet device type allowing the locking of the rod control stem 3 when the latter is in the top position.

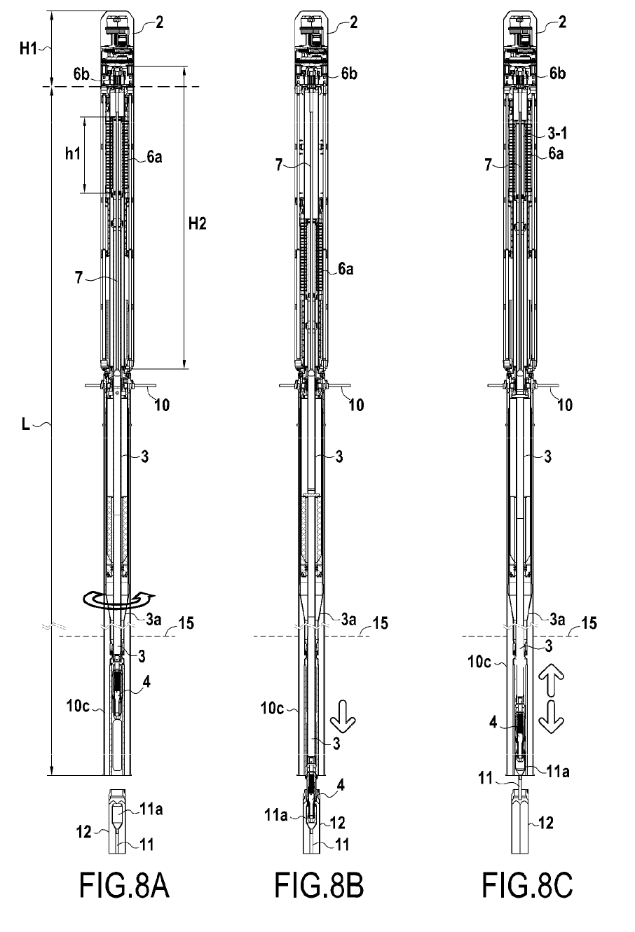

A translation and rotation of the rod control stem 3 makes it possible to unlock the rod control stem 3 in the top position as shown in FIG. 8A to then allow its descending vertical translation to grab an absorbent control rod 11 inside its housing represented 12 in FIG. 8B and to make a variable upward translation, of said absorbent control rod 11 to allow and control the activity of the reactor as represented in FIG. 8C.

The mechanical locking device 3b in the top position by a bayonet system makes it possible to prevent the fall of the rod control stem 3 even in the event of a power cut-off of the magnetic suction cup 8 and thus makes it possible to dismantle the upper holding compartment by leaving the rod control stem 3 inside the guide sheath 3a. In a known manner, the device for mechanical locking of the rod control stem in the top position includes locking lugs cooperating with notches in a groove of the bearing 3c inside the guide sheath when the stem 3 is rotationally positioned in such a way that the lugs coincide with said notches. A safety bushing makes it possible to hold said locked lugs in their notches, said bushing cooperating with holding springs and able to be disengaged by upper translation of the assembly when the device is unlocked.

A chassis 2d forms a mechanical structure of the compartment 2 that supports and guides all the elements of the movable equipment above the closing slab 10 and on which the metal sheets constituting the wall of the casing 2c of the compartment 2 are fastened.

All the walls 2c of the upper compartment 2, cylindrical wall 5a-5b of the sealing shroud 5, first outer component 6a-1 and first inner component 6a-2, elements 8-1 and 8-2 of the magnetic suction cup 8 and elements 9-1 and 9-2 of the magnetic damper device 9 along with the second outer component 6b-2 and second outer component 6b-1, guide sheath 3a, rod control tube 3 and guide bar 7 are all coaxially arranged along the vertical longitudinal axis XX′ of the device.

Several guide bearings 3d, 3e provide the axial guiding of the rod control stem 3 inside the guide sheath 3a. The upper bearing 3c is in an argon atmosphere and bears the locking device in the top position of the rod control stem 3.

The fastening of the lower flange 5d of the shroud 5 to an upper flange of the sleeve 10b or of the guide tube 3a achieved by way of two sealing O-rings.

To avoid a residual risk of clogging of the air gap (gap) between the shroud and said first inner component of the magnetic coupling in translation, it is possible to establish a counter-pressure of argon inside the shroud 5 to prevent any return of sodium aerosol and/or heat this area to 100° C. in such a way as to avoid the risk of solid aerosol deposits which could block the vertical translation of the inner elements of the movable equipment, namely the first inner component 6a-2 integral with the rod control stem 3 which is done without contact with the wall 5a and by magnetic linkage with the first outer component 6a-1 of the first synchronous magnetic coupling system in translation 6a.

The synchronous reducing gears 2a-1 and 2b-1 associated with their respective gear train 2a-2 and 2b-2 cooperate with position sensors (not represented) which provide the control of the translation of the movable equipment in the upper compartment 2 outside the shroud 5 and the rotation of the rod control stem. These sensors particularly control the position of the outer part 6a-1 of the first magnetic coupling system 6a in translation between translational track end positions as well as the rotational position of the rod control stem between end positions of the clamps 4b of the gripper 4 in the retracted position and expansion position and blocking on end stop surfaces 11b of the upper housing 11a of the absorbent control rod 11.

By way of illustration, the device 1 is dimensioned as follows:
the outer diameter of the wall 2c of the upper compartment 2 is of approximately 350 mm;
the outer diameter of the widest part of the guide sheath is of approximately 300 mm;
the total length L of the guide sheath extending beneath the closing slab 10 of the vat 13 is of approximately L=approximately 10 m;
the height H1 of the upper compartment 2 is approximately H1=4 m, and
the height H2 of the shroud 5 inside the upper compartment 2 is approximately H2=3 m.

1. A device for handling an absorbent rod for controlling a nuclear reactor, comprising:
an upper motor compartment positioned on a closing slab of a reactor vat, enclosing motorized system for transmitting control for displacements of a first stem which is a rod control stem,
an upper part of said rod control stem extending in said motor compartment and a lower part of said rod control stem extending in a guide sheath extending inside said vat and crossing a cavity of the closing slab of the reactor vat, and
a device for gripping absorbent rod configured as a gripper, fastened to the lower end of said rod control stem, said gripper being able to seize the upper end of an absorbent rod arranged in the extension of and in alignment with the rod control stem,
a sealed static confinement chamber made of non-magnetic material arranged inside said upper compartment, in the form of a shroud, comprising a side wall of revolution, open at its base and fastened in a sealed manner to the closing slab of the reactor vat around the cavity of said closing slab crossed by said guide sheath,
a first synchronous magnetic coupling system for transmitting linear translational movement without mechanical contact, comprising:
a first outer component comprising a block of one or more permanent magnets, said block being arranged inside said upper motor compartment outside said confinement chamber, and able to be vertically translated, and
a first inner component comprising at least one soft ferromagnetic element, arranged inside said confinement chamber, integral with the upper part of said rod control stem, the magnetic coupling force of said first outer component and said first inner component enabling, when the first outer component is displaced in vertical translation, said first inner component and the rod control stem to follow a displacement in said vertical translation,
said motor compartment comprising first motorized mechanical system for transmitting vertical translational displacements of said first outer component of said first magnetic coupling system.

2. The device according to claim 1 wherein:
said upper motor compartment comprises second motorized mechanical system for transmitting rotational displacements of said rod control stem along a longitudinal axis (XX′) of said rod control stem; and
said gripper is able to be actuated to respectively seize or release an end of said control rod by rotation of said rod control stem along said longitudinal axis (XX′).

3. The device according to claim 2, wherein said device comprises a second stem configured as a guide shaft, inserted into a center cavity of the upper part of said rod control stem in a said longitudinal axis of said side wall of revolution of said confinement chamber, said rod control stem being configured to slide with respect to said guide shaft when it is translationally actuated by said first magnetic coupling system, said guide shaft being blocked in vertical translation and configured to be rotationally driven about said longitudinal axis, said guide shaft being configured to cooperate with said center cavity so that the rotation of the guide shaft about said longitudinal axis drives the rotation of the rod control stem about said longitudinal axis.

4. The device according to claim 3, wherein said device comprises a second synchronous magnetic coupling system for transmitting rotational movement without mechanical contact comprising:
a second inner component comprising at least one soft ferromagnetic element, arranged inside said confinement chamber, fixed in vertical translation, configured to be rotationally displaced along the longitudinal axis of said chamber, integral with said guide shaft, fixed in vertical translation, and
a second outer component comprising a block of one or more permanent magnets, said block being arranged inside said upper motor compartment outside said confinement chamber, and configured to be rotationally displaced along the longitudinal axis of said side wall of revolution of said confinement chamber, and a magnetic coupling force of said second outer component and said second inner component of said second magnetic coupling system enabling, when said second outer component is rotationally displaced, for said second inner component, said guide shaft and said rod control stem follow a same displacement in said rotation along a same longitudinal axis.

5. The device according to claim 2 wherein said upper compartment enclosing mechanical system for transmitting rotational displacement is of pinion gear type.

6. The device according to claim 1, wherein said device comprises a device for emergency shutdown of the reactor comprising a component configured as a magnetic suction cup comprising a permanent magnet combined with an electromagnetic coil inside said upper motor compartment outside said confinement chamber so that:
said suction cup is integral with a suction cup base, said motor compartment comprising first motorized mechanical system for transmitting control for translational displacements of said suction cup base;
an electrical activation of said electromagnetic coil modifies a magnetic field generated by the magnet of said magnetic suction cup which closes on a metal part of said first outer component of the first magnetic coupling system and creates a link by magnetic bonding between said suction cup and the first outer component of the first magnetic coupling system thus providing the translational displacement of said first outer component by displacement of said suction cup base, and
an absence of electrical activation of said electromagnetic coil re-establishes the magnetic field of the magnet of said magnetic suction cup which field is no longer directed onto said metal part of the first outer component of the first magnetic coupling system and thus causes a gravitational fall of said first magnetic coupling system and therefore a gravitational fall of said absorbent rod when the latter is seized by said gripper at a lower end of the rod control stem.

7. The device according to claim 1, wherein said device further comprises a fall damping device constituting a magnetic damper comprising a first damper element consisting of a permanent magnet configured to slide in relative displacement facing a second damper element made of materials of low electrical resistance, arranged under the first damper element, a relative displacement of said first damper element with respect to said second damper element being configured to occur when a device for automatic shutdown of the reactor permits a gravitational fall of said absorbent rod.

8. The device according to claim 7, wherein said fall damping device constituting a magnetic damper comprises:
a second damper element in the shape of a ferrule, fixed, coaxially arranged in a bottom part of said upper compartment outside said confinement chamber, and
a first damper element consisting of a permanent magnet coaxially fastened to said first outer component of said first magnetic coupling system, configured to slide coaxially inside said ferrule-shaped second damper element in a annular space between said ferrule and a cylindrical side wall of said confinement chamber, when said device for automatic shutdown of the reactor permits the release of said first outer component of said first magnetic coupling system.

9. The device according to claim 6, wherein said gripper at the lower end of the rod control stem forms a grab comprising a plurality of fingers arranged in the direction of the longitudinal axis of the rod control stem in a retracted position and configured to pivot or bend to move angularly away from the longitudinal axis of the rod control stem and/or expand radially, reversibly, under an action of axial rotation of the rod control stem, to cooperate with the upper part of the absorbent rod and block itself there to seize the absorbent rod.

10. The device according to claim 7, wherein said gripper comprises at least two parts cooperating with one another in a helical connection by screwing with:
a first threaded part integral with the end of the rod control stem, said first male fixed part comprising downstream of a threaded part, an area with a widened cross section diameter, and
a second tapped part configured to be translationally displaced with respect to said first threaded part by screwing one with respect to the other,
said second tapped part bearing said flexible fingers which move apart radially when they encounter said area of widened diameter of said first part due to the relative translation of said threaded part and tapped part by relative screwing resulting from a rotation of the rod control stem driving a relative rotation of the first threaded part with respect to the second tapped part.

11. The device according to claim 1, wherein said first magnetic coupling system for transmitting linear translational movement comprises:
a first outer component consisting of a block of one or more permanent magnets coaxially arranged to said side wall of revolution, in the form of a stack of permanent magnet rings, separated by rings of soft iron plates, and
a first inner component coaxially arranged with said side wall of the confinement chamber and comprising at least a stack of soft iron rings fastened to the upper part of the rod control stem.

12. The device according to claim 11, wherein both said first inner component and said first outer component each comprise alternating permanent magnets separated by soft ferromagnetic elements.

13. The device according to claim 4, wherein said second magnetic coupling system for transmitting rotational movement comprises:
a second outer component consisting of an annular block of permanent magnet coaxially arranged with said side wall of revolution of the chamber and
a second inner component consisting of at least a soft iron element fastened to the upper part of said guide shaft coaxially arranged with said side wall of revolution of the chamber.

14. The device according to claim 13, wherein said second magnetic coupling system for transmitting rotational movement comprises:
a second outer component consisting of an assembly of permanent magnets separated by soft iron elements arranged side-by-side at a same radial distance from said side wall of revolution of the confinement chamber, the outline of each of said elements each having a shape of a circular arc section, and
a second inner component consisting of an assembly of soft iron elements arranged side-by-side at the same radial distance from the longitudinal axis of the upper part of said guide shaft, the outline of each of said elements each having a shape of a same circular arc section.

15. A method for handling an absorbent rod used to control the neutron flow emitted by fuel assemblies of a nuclear reactor, by relative translation of an absorbent rod with respect to a sheath arranged between fuel rods using a handling device according to claim 1.

16. The method according to claim 15 wherein said device comprises a device for emergency shutdown of the reactor comprising a component configured as a magnetic suction cup comprising a permanent magnet combined with an electromagnetic coil inside said upper motor compartment outside said confinement chamber so that:
said suction cup is integral with a suction cup base, said motor compartment comprising first motorized mechanical system for transmitting control for translational displacements of said suction cup base;
an electrical activation of said electromagnetic coil modifies a magnetic field generated by the magnet of said magnetic suction cup which closes on a metal part of said first outer component of the first magnetic coupling system and creates a link by magnetic bonding between said suction cup and the first outer component of the first magnetic coupling system thus providing the translational displacement of said first outer component by displacement of said suction cup base, and
an absence of electrical activation of said electromagnetic coil re-establishes the magnetic field of the magnet of said magnetic suction cup which field is no longer directed onto said metal part of the first outer component of the first magnetic coupling system and thus causes a gravitational fall of said first magnetic coupling system and therefore a gravitational fall of said absorbent rod when the latter is seized by said gripper at a lower end of the rod control stem, and
wherein said device further comprises a fall damping device constituting a magnetic damper comprising a first damper element consisting of a permanent magnet configured to slide in relative displacement facing a second damper element made of materials of low electrical resistance, arranged under the first damper element, a relative displacement of said first damper element with respect to said second damper element being configured to occur when a device for automatic shutdown of the reactor permits a gravitational fall of said absorbent rod; said fall damping device constituting a magnetic damper comprising:
a second damper element in the shape of a ferrule, fixed, coaxially arranged in a bottom part of said upper compartment outside said confinement chamber, and
a first damper element consisting of a permanent magnet coaxially fastened to said first outer component of said first magnetic coupling system, configured to slide coaxially inside said ferrule-shaped second damper element in a annular space between said ferrule and a cylindrical side wall of said confinement chamber, when said device for automatic shutdown of the reactor permits the release of said first outer component of said first magnetic coupling system, and
wherein the reactor is automatically shut down by free gravitational fall of the rod control stem and of the absorbent rod that is fastened thereto by said gripper, by cutting any electrical power supply of said magnetic suction cup and said magnetic damper device.
